(19) United States
(12) Patent Application Publication
(10) Pub. No.: US 2022/0099115 A1
(43) Pub. Date: Mar. 31, 2022

(54) CONNECTOR AND STORAGE BOX CONTAINING SAME

(71) Applicant: Hong CHEN, Chengdu (CN)

(72) Inventor: Hong CHEN, Chengdu (CN)

(21) Appl. No.: 17/310,108

(22) PCT Filed: Aug. 18, 2020
(86) PCT No.: PCT/CN2020/109714

§ 371 Date: Jul. 16, 2021

(30) Foreign Application Priority Data
Sep. 26, 2019 (CN) 201921623444.5
Dec. 23, 2019 (CN) 201922335144.3

(51) Int. Cl. F16B 1/00; B65D 21/02

(52) U.S. Cl. CPC F16B 1/00; F16B 2001/0035; B65D 21/0224

(57) ABSTRACT

The invention provides a connector and a storage box. The connector comprises a connector body extended to form a first and second snap-fit portion nested with each other. The connector body is provided with a first plug-in unit and/or a second plug-in unit. The first plug-in unit comprises three first plug-in structures of which the direction vectors are vertical to each other in pairs and all different from the extending direction of the snap-fit portions and the second plug-in unit comprises three second plug-in structures of which the direction vectors are perpendicular to each other in pairs, both the first plug-in structure and the second plug-in structure comprising at least one direction vector perpendicular to the extending direction of the first snap-fit portion. The first and the second snap-fit portion of two connectors can be nested with each other and cannot slide relative to each other.

### TECHNICAL FIELD

The invention relates to a connection structure, in particular to a connector and a storage box containing the same.

### BACKGROUND

In order to facilitate the storage and sorting of items, more and more places need to use storage boxes for storage. In order to facilitate the transportation and storage of the storage boxes, the storage boxes are generally arranged in an assemblable structure. At this time, it is generally required to insert the plate body to the connector, so as to assemble the storage box by means of the connector and the plate body.

However, when these storage boxes are stacked together, they are prone to slip with each other, which results in a plurality of storage boxes cannot be stably stacked together.

### SUMMARY OF THE INVENTION

According to one aspect of the present invention, a connector is provided.

The connector comprises a connector body; the surface of the connector body extends along a first direction vector to form a first snap-fit portion; the surface of the connector body extends along a second direction vector to form a second snap-fit portion that can be nested with the first snap-fit portion. The first direction vector and the second direction vector are perpendicular to each other, and the distance between the second snap-fit portion and the first snap-fit portion increases or remains constant as the second snap-fit portion extends; the connector body is provided with at least one of a first plug-in unit and a second plug-in unit. The first plug-in unit comprises three first plug-in structures provided on the surface of the connector body. The three first plug-in structures are formed by extending along the third direction vector, the fourth direction vector and the fifth direction vector respectively. Any two of the third direction vector, the fourth direction vector and the fifth direction vector are perpendicular to each other, and any one of the third direction vector, the fourth direction vector and the fifth direction vector is different from the first direction vector or the second direction vector. At least one of the third direction vector, the fourth direction vector, and the fifth direction vector is perpendicular to the first direction vector. The second plug-in unit comprises three second plug-in structures provided on the surface of the connector body, and the three second plug-in structures are formed by extending along the third direction vector, the fourth direction vector and the fifth direction vector respectively.

When using the connector, in the first method of application, a plurality of plates can be plugged into the first plug-in structures of a plurality of connectors to assemble a storage box;

In the second method of application, a plurality of ribs can be plugged into the second plug-in structures of the plurality of connectors, and a plurality of plates can be inserted into the plurality of ribs to assemble a storage box;

In the third method of application, a plurality of ribs can be plugged into the second plug-in structure of a plurality of connectors, and a plurality of plates can be plugged into the first plug-in structures of a plurality of connectors and a plurality of ribs to assemble a storage box;

After the storage box being assembled, the first snap-fit portion and the second snap-fit portion on the connector body are located outside the storage box.

Therefore, when a plurality of storage boxes are stacked together, the first snap-fit portion on the connector of one of the storage boxes and the second snap-fit portion on the connector of the adjacent storage box are nested with each other to avoid the plurality of storage boxes stacked together from sliding with respect to each other, which ensures the plurality of storage boxes stably stacking together.

In some embodiments, the contours of the first snap-fit portion and the second snap-fit portion are configured such that when the first snap-fit portion and the second snap-fit portion are expanded relative to the first axis, the contour of the first snap-fit portion and the contour of the second snap-fit portion are symmetrical with respect to the first axis; the first axis is formed on the intersection line of the first plane perpendicular to the first direction vector and the second plane perpendicular to the second direction vector.

Therefore, when two adjacent storage boxes are stacked together in alignment on their sides, the first snap-fit portion and the second snap-fit portion on the corresponding connectors on the two storage boxes are nested together to ensure the storage boxes can be stacked together neatly, which further reduces the possibility of the storage boxes stacked together from slipping off.

In some embodiments, the first snap-fit portion and the second snap-fit portion are arranged such that when the first snap-fit portion of one of the connectors is nested in the second snap-fit portion of the other connector, the first direction vector of one of the connectors is parallel and opposite to the second direction vector of the other one of the connectors. Therefore, it can be ensured that the storage boxes can be neatly and stably stacked along the extension direction of at least one of the first direction vector and the second direction vector.

In some embodiments, the first snap-fit portion is a protrusion provided on the surface of the connector body, and the second snap-fit portion is a first groove provided on the surface of the connector body cooperating with the protrusion. Therefore the processing and manufacturing of the first snap-fit portion and the second snap-fit portion are facilitated.

In some embodiments, the protrusion comprises at least one first prism and at least one second prism not parallel to the at least one first prism provided on the surface of the connector body. Therefore, it can be ensured that when the connector moves along the extension direction of one side of the first prism or the second prism, two nested connectors will not slip.

In some embodiments, the first prism is provided at a non-end position of the second prism.

Therefore, it can be ensured that when the connector moves along the extending direction of one side of the first prism and the second prism, two nested connectors will not slip; moreover, when both ends of the first prism are provided with the second prisms, two nested connectors can only be disassembled by moving in the direction of the first direction vector or the second direction vector, but cannot move in other directions to ensure the stability of nesting of the connectors and to avoid the nested connectors from slipping relative to each other.

In some embodiments, the first prism is provided at the central position of the second prism, the first prism and the second prism are both configured as a long rectangular structure with equal width extending straightly. The first prisms are perpendicular to the second prisms. As a result, symmetrical protrusions are formed. After the connectors and the plates are assembled into storage boxes, a plurality of storage boxes can be stacked with end faces aligned or can be stacked staggered with each other, with the stacking direction not restricted.

In some embodiments, when the first plug-in unit and the second plug-in unit are provided at the same time, the second plug-in structure is configured to connect two adjacent first plug-in structures. As a result, the ribs inserted into the second plug-in structure can also be inserted into the plate bodies, so as to further ensure the stability of the assembly of the plate bodies.

In some embodiments, the protrusion is provided on the first surface perpendicular to the first direction vector of the connector body, the first groove is provided on the second surface perpendicular to the second direction vector of the connector body. The second surface is adjacent to the first surface. Thus, when the first snap-fit portion and the second snap-fit portion of two connectors are nested with each other and the second surface of one connector abuts against the first surface of the other one connector, the first surfaces and the second surface that abut against each other can support the nested connectors.

In some embodiments, the height of the protrusion is equal to the depth of the first groove.

In some embodiments, the surface of the connector body is provided with a first magnetic component, the outer surface of which is parallel to both the first direction vector and the second direction vector. Thus the flatness of the storage box formed is ensured after the plate body with the magnetic component is connected to the first magnetic component.

In some embodiments, the first magnetic component is provided on the third surface of the connector body, and the third surface is not provided with the first snap-fit portion, the second snap-fit portion, the first plug-in structure or the second plug-in structure.

When the connector and the plate are assembled into the storage box, a plate body with a magnetic component can be magnetically connected to the first magnetic component, so that the plate body with a magnetic component can be disassembled with the connector without removing the plate from the first plug-in structure of the connector to realize the picking and placing of the items in the storage box.

In some embodiments, the third surface is perpendicular to the first surface and the second surface. Thus, the flatness of the storage box formed after the plate body with the magnetic component is connected to the first magnetic component is ensured.

In some embodiments, the third surface is a surface adjacent to the first surface and the second surface. Thus, the flatness of the storage box formed after the plate body with the magnetic component is connected to the first magnetic component is ensured.

According to one aspect of the present invention, a storage box is provided.

The storage box comprises eight connectors and three sets of plates; each plate is provided with at least one plate body cooperated with the first plug-in structure; at least one set of the three sets of plates comprises two plates with the same shape; the four corners of each plate body are individually cooperated with one connector; the plate bodies of each two sets of plates are provided perpendicular to each other; two plate bodies in one set of plates are provided parallel to each other; the connectors are the aforementioned connectors.

In the first method of application, the plate body can be plugged into the first plug-in structure of the connector to assemble into a storage box;

In the second method of application, a plurality of ribs can be plugged into the second plug-in structure of the plurality of connectors, and a plurality of plate bodies can be plugged into the plurality of ribs to assemble a storage box;

In the third method of application, a plurality of ribs can be plugged into the second plug-in structure of a plurality of connectors, and a plurality of plate bodies can be plugged into the first plug-in structure of a plurality of connectors and a plurality of ribs to assemble a storage box;

After the storage box being assembled, the first snap-fit portion and the second snap-fit portion on the connector body are located outside the storage box.

Therefore, when a plurality of storage boxes are stacked together, the first snap-fit portion on the connector of one storage box and the second snap-fit portion on the connector of the adjacent storage box are nested with each other to avoid the plurality of storage boxes stacked together from sliding relative to each other, which ensures that the plurality of storage boxes can be stably stacked together.

In some embodiments, the storage box further comprises a rib body cooperated with the second plug-in structure and provided with a mounting groove cooperated with the plate body, both ends of which are connected with connectors. Therefore, the side edges of the plate bodies can be protected by the ribs, and the strength of the storage box can be improved.

In some embodiments, the ribs are provided with two installation grooves perpendicular to each other and are arranged such that when the ribs are fitted in the second plug-in structure, each installation groove is individually communicated with a first plug-in structure. Therefore, all side edges of the plate bodies can be protected by the ribs, and the strength of the storage box can be improved.

In some embodiments, the depth of the second plug-in structure is greater than the depth of the first plug-in structure. Therefore, the ribs can be supported by the connector.

According to another aspect of the present invention, a further storage box is provided.

The storage box comprises eight connectors and three sets of plates; each plate is provided with at least one plate body cooperated with the first plug-in structure; at least one set of plates comprises two plates with the same shape; where the four corners of two sets of plates are individually cooperated with a connector, and the four corners of at least one plate of the other set of plates are provided with a second magnetic component corresponding to the first magnetic component; the plate bodies of each two sets of plates are arranged perpendicular to each other; two plate bodies of one set of plates are arranged in parallel with each other; the connector is the aforementioned connector.

In the first method of application, the plate bodies can be plugged into the first plug-in structure of the connector to assemble into a storage box;

In the second method of application, a plurality of ribs can be plugged into the second plug-in structure of the plurality of connectors, and a plurality of plate bodies can be plugged into the plurality of ribs to assemble into a storage box;

In the third method of application, a plurality of ribs can be plugged into the second plug-in structure of a plurality of connectors, and a plurality of plate bodies can be plugged into the first plug-in structure of a plurality of connectors and a plurality of ribs to assemble into a storage box;

In the fourth method of application, the plate body without the second magnetic component can be plugged into at least one of the first plug-in structure and the second plug-in structure, and the plate body with the second magnetic component is magnetically connected to the first magnetic component of the connector by magnetism.

After the storage box being assembled, the first snap-fit portion and the second snap-fit portion on the connector body are located outside the storage box.

Therefore, when a plurality of storage boxes are stacked together, the first snap-fit portion on the connector of one storage box and the second snap-fit portion on the connector of the adjacent storage box are nested with each other to avoid the plurality of storage boxes stacked together from sliding relative to each other to ensure that the plurality of storage boxes are stacked together stably; The plate body with the magnetic component can be disassembled from the connector without removing the plate from the first plug-in structure of the connector, therefore realizing the picking and placing of the items in the storage box.

### BRIEF DESCRIPTION OF THE DRAWINGS

FIG. 1 is a structural schematic diagram of the connector according to the first embodiment of the present invention;

FIG. 2 is a structural schematic diagram of the connector shown in FIG. 1 in another view;

FIG. 3 is a structural schematic diagram of the connector shown in FIG. 1 in another view;

FIG. 4 is a structural schematic diagram of the connector shown in FIG. 1 in another view;

FIG. 5 is a sectional structural schematic diagram of the connector shown in FIG. 4 taken along A-A;

FIG. 6 is a sectional structural schematic diagram of the connector shown in FIG. 4 taken along B-B;

FIG. 7 is a structural schematic diagram of the first snap-fit portion and the second snap-fit portion of the connector shown in FIG. 1 unfolding along the first axis;

FIG. 8 is a structural schematic diagram of the connector according to the second embodiment of the present invention;

FIG. 9 is a structural schematic diagram of the connector shown in FIG. 8 in another view;

FIG. 10 is a structural schematic diagram of the connector shown in FIG. 9 taken along C-C;

FIG. 11 is a structural schematic diagram of the storage box of the first embodiment of the present invention;

FIG. 12 is a structural schematic diagram of the storage box shown in FIG. 11 in another view;

FIG. 13 is a structural schematic diagram of the storage box shown in FIG. 12 taken along D-D;

FIG. 14 is a structural schematic diagram of the storage box shown in FIG. 12 taken along E-E;

FIG. 15 is a structural schematic diagram of a storage box according to the second embodiment of the present invention;

FIG. 16 is a structural schematic diagram of the storage box shown in FIG. 15 in another view;

FIG. 17 is a structural schematic diagram of the storage box shown in FIG. 16 taken along F-F;

FIG. 18 is a structural schematic diagram of the storage box shown in FIG. 15 in a disassembled state;

FIG. 19 is a structural schematic diagram of a storage box according to a third embodiment of the present invention;

FIG. 20 is a structural schematic diagram of a storage box according to a fourth embodiment of the present invention;

FIG. 21 is a structural schematic diagram of the storage box shown in FIG. 20 in another view;

FIG. 22 is a sectional structural schematic diagram of the storage box shown in FIG. 21 taken along G-G;

FIG. 23 is a structural schematic diagram of the storage box in stacked state according to the first embodiment of the present invention;

FIG. 24 is an enlarged structural schematic diagram of the storage box of FIG. 23 in the stacked state at H position;

FIG. 25 is a structural schematic diagram of the storage box in the stacked state of the second embodiment of the present invention.

### DETAILED DESCRIPTION

The present invention will be described in further detail below in conjunction with the accompanying drawings.

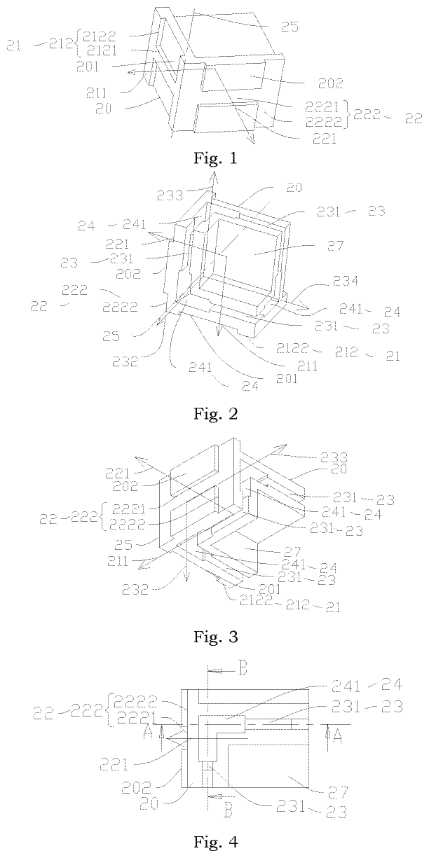

FIGS. 1 to 7 schematically show a connector according to the first embodiment of the present invention.

Reference to FIGS. 1 to 3, the connector comprises a connector body 20, the surface of which is provided with a first snap-fit portion 21 which extends along a first direction vector 211; the surface of the connector body 20 is provided with a second snap-fit portion 22 which extends along a second direction vector 221 and can be nested with the first snap-fit portion 21. The first direction vector 211 and the second direction vector 221 are arranged perpendicular to each other, and the distance between the second snap-fit portion 22 and the first snap-fit portion increases or remains unchanged as the second snap-fit portion extends; the connector body 20 is provided with at least one of a first plug-in unit 23 and a second plug-in unit 24, where the first plug-in unit 23 comprises three first plug-in structures 231, and the first plug-in structures 231 can be provided on the surface of the connector body 20; the first one of the three first plug-in structures 231 is formed by extending along the third direction vector 232, the second one of the first plug structures 231 is formed by extending along the fourth direction vector 233, and the third one of the first plug structures 231 is formed by extending along the fifth direction vector. The third direction vector 232, the fourth direction vector 233, and the fifth direction vector 234 are perpendicular to each other, and neither of which being in the same direction with the first direction vector 211 nor the second direction vector 221, moreover, at least one of the third direction vector 232, the fourth direction vector 233, and the fifth direction vector 234 is perpendicular to the first direction vector 211; the second plug-in unit 24 comprises three second plug-in structures 241 can be provided on the surface of the connector body 20; the first one of the three second plug-in structures 241 is formed by extending along the third direction vector 232, the second one of the three second plug-in structures 241 is formed by extending along the fourth direction vector 233, and the third one of the three second plug structure 241 is formed by extending along the fifth square vector.

When using the connector, in the first method of application, a plurality of plate bodies 31 can be plugged into the first plug-in structures 231 of the plurality of connectors to assemble a storage box.

In the second method of application, a plurality of ribs 40 can be plugged into the second plug-in structures 241 of a plurality of connectors, and a plurality of plate bodies 31 can be plugged into the plurality of ribs 40 to assemble into a storage box.

In the third method of application, a plurality of ribs 40 can be plugged into the second plug-in structure 241 of a plurality of connectors, and a plurality of plate bodies 31 can be plugged into the first plug-in structures 231 of the plurality of connectors and a plurality of ribs 40 to assemble into a storage box.

After the storage box being assembled, the first snap-fit portion 21 and the second snap-fit portion 22 on the connector body 20 are located outside the storage box.

Therefore, when a plurality of storage boxes are stacked together, the first snap-fit portion 21 on the connector of one storage box and the second snap-fit portion 22 on the connector of a adjacent storage box are nested with each other, so as to avoid the plurality of storage boxes stacked together from sliding relative to each other, which ensures that the plurality of storage boxes are stably stacked together.

Referring to FIGS. 1 and 7, in some embodiments, the contours of the first snap-fit portion 21 and the second snap-fit portion 22 are arranged such that when the contours of the first snap-fit portion 21 and the second snap-fit portion 22 deploy with respect to the first axis 25, the contours of the first snap-fit portion 21 and the second snap-fit portion 22 are symmetrical with respect to the first axis 25, as the first snap-fit portion 21 and the second snap-fit portion 22 can be embedded in each other, that is, assuming that the first snap-fit portion 21 can rotate around the first axis 25 to the position where the second snap-fit portion 22 locates, the first snap-fit portion 21 can be nested in the second snap-fit portion 22; The first axis 25 is formed on the intersection of a first plane perpendicular to the first direction vector 211 and a second plane perpendicular to the second direction vector 221.

Thus, when two adjacent storage boxes are stacked with their sides in alignment, the first snap-fit portion 21 and the second snap-fit portion 22 on the corresponding connectors of the two storage boxes are nested together, so as to ensure that the storage boxes can be stacked neatly and further reduce the possibility of the stacked storage boxes from sliding off.

In some embodiments, the first snap-fit portion 21 and the second snap-fit portion 22 are arranged such that when the first snap-fit portion 21 of one connector is nested in the second snap-fit portion 22 of the other connector, the first direction vector 211 of the first snap-fit portion 21 is parallel to the second direction vector 221 of the second snap-fit portion 22 nested with it outside, and the directions of the first direction vector 211 and the second direction vector 221 are opposite. Therefore, it can be ensured that the storage boxes can be stacked neatly and stably along the extension direction of at least one of the first direction vector 211 and the second direction vector 221.

Referring to FIGS. 1 to 3 and 5, in some embodiments, the first snap-fit portion 21 is a protrusion 212 integrally formed, processed, or connected to the surface of the connector body 20, and the second snap-fit portion 22 is a first groove 222 integrally formed or processed on the surface of the connector body 20 and cooperated with the protrusion 212. Thus the processing and manufacturing of the first snap-fit portion 21 and the second snap-fit portion 22 is facilitated.

In some embodiments, the protrusion 212 comprises at least one first prism 2121 and at least one second prism 2122 integrally formed, processed, or connected to the surface of the connector body 20; the second prism 2122 is not parallel to the first prism 2121.

For example, when the end of a second prism is provided on one end of the first prism, protrusions of “V” shaped or “L” shaped can be formed according to the difference between the angle between the first prism and the second prism.

For another example, when the ends of two second prisms are provided on the two ends of the first prism respectively, or the ends of two first prisms are provided on the two ends of the second prism respectively, protrusions of “ [symbol] ” shaped can be formed.

In some embodiments, the first prism is provided at a non-end position of the second prism. For example, when providing only one second prism, protrusion of “T”-shaped can be formed.

Therefore, two connectors nested with each other will not slip relative to each other when the connector is moved in the direction from the joint of the first prism and the second prism to the free end of the first prism or the second prism, as long as the first prism is not parallel to the second prism, whether the first prism is located at the end of the second prism or not.

In some embodiments, both ends of the first prism 2121 are provided with the second prism 2122, and the first prism 2121 is connected to the non-end portion of the second prism 2122. Therefore, the two connectors will not move relative to each other while the connectors are moved in the direction except the first direction vector 211 and the second direction vector 221 when the first snap-fit portion 21 and the second snap-fit portion 22 of the two connectors are nested with each other, so as to ensure the stability of the nesting of the connectors and avoid relative slippage of the connectors nested with each other.

Referring to FIGS. 1, 3, and 7, in some embodiments, the first prism 2121 is provided at the middle portion of the second prism 2122, and the first prism 2121 and the second prism 2122 are both arranged to be an elongated strip structure with equal width extending straightly, the first prism 2121 and the second prism 2122 are perpendicular to each other; the second prism 2122 is provided with a cross-shaped protrusion 212 provided at the middle portion of the first prism 2121, or the second prism 2122 is provided with a “H” shaped protrusions 212 provided at both ends of the first prism 2121.

As a result, symmetrical protrusion 212 is formed. After the connectors and the plates are assembled into storage boxes, a plurality of storage boxes can be stacked with their end faces aligned or staggered with each other, without the stacking direction being limited.

Referring to FIGS. 1, 3, 4 and 7, a first recessed portion 2221 cooperated with the first prism 2121 and a second recessed portion 2222 are integrally formed or processed on the surface of the connector body 20

In other embodiments, the first snap-fit portion further can comprise both protrusion and groove, and configured such that a groove is provided at the corresponding position of the second snap-fit portion with the distance from which to the protrusion of the first snap-fit portion being equal to the distance from which to the first axis; a protrusion is provided at the corresponding position of the second snap-fit portion with the distance from which the protrusion of the and the first axis being equal to the distance between the groove of the first snap-fit portion and the first axis, so that the protrusion and the groove of the first snap-fit portion can cooperated with the protrusion and the groove of the second snap-fit portion.

Referring to FIGS. 2 to 6, in some embodiments, when the first plug-in unit 23 and the second plug-in unit 24 are both provided, the second plug-in structure 241 is configured to connect two adjacent first plug-in structures 231.

Continuing referring to FIGS. 2 to 6, in some embodiments, the first plug-in structure 231 and the second plug-in structure 241 are both sink grooves integrally formed or processed on the connector body 20.

In some embodiments, referring to FIGS. 2 to 4, the width of the sink groove of the first plug-in structure 231 is smaller than that of the second plug-in structure 241, and a side of the sink groove of the first plug-in structure 231 towards the second plug-in structure 241 communicates with the second plug-in structure 241, a side of the first plug-in structure 231 facing away from the second plug-in structure 241 communicates with the outside.

As a result, the ribs 40 plugged into the second plug-in structure 241 can also be plugged into by the plate bodies 31, so as to further ensure the stability of the assembly of the plate bodies 31.

Referring to FIGS. 1 to 3 and 5, in some embodiments, the protrusion 212 is provided on the first surface 201 perpendicular to the first direction vector 211 of the connector body 20, and the first groove 222 is provided on the second surface 202 perpendicular to the second direction vector 221 of the connector body 20, the second surface 202 is adjacent to the first surface 201. Thus, when the first snap-fit portion 21 and the second snap-fit portion 22 of two connectors are nested with each other and the second surface 202 of one connector abut against the first surface 201 of the other connector, the first surface 201 and the second surface 202 abut against each other can support the nested connectors.

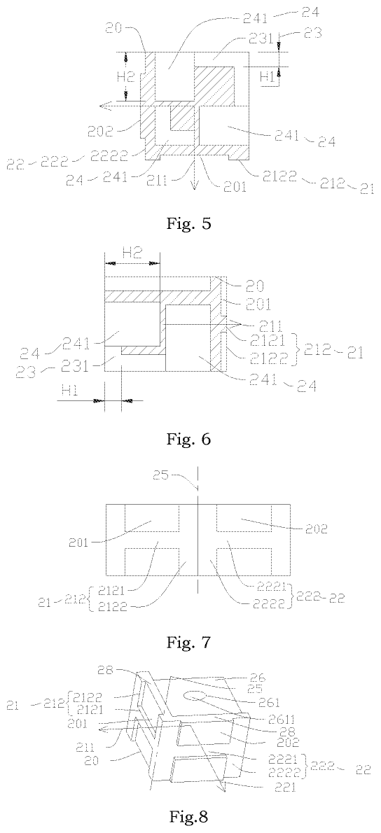

Referring to FIG. 5, in some embodiments, the height of the protrusion 212 is equal to the depth of the first groove 222. In this way, when the protrusion 212 is nested in the first groove 222, the bottom of the first groove 222 can support the top of the protrusion 212. Meanwhile, when the second surface 202 is perpendicular to the first surface 201, the first surface 201 of one of the inter-nested connectors abuts against the second surface 202 of the other connector.

As shown in FIGS. 2 to 4, in some embodiments, a second groove 27 is integrally formed or processed on the connector body 20 to reduce the weight of the connector body 20. The second groove 27 may be provided on a surface other than the first surface 201 and the second surface 202.

Referring to FIG. 5, in some embodiments, the depth of the second plug-in structure 241 is greater than the depth of the first plug-in structure 231. Thus, the rib 40 can be supported by the connector.

FIGS. 8 to 10 schematically show a connector according to a second embodiment of the present invention.

Referring to FIGS. 8 to 10, the connector of this embodiment may be the same as or different from the connector of the first embodiment. In the embodiment, the surface of the connector body 20 of the connector is provided with a first magnetic component 261, the outer surface 2611 of which being parallel to both the first direction vector 211 and the second direction vector 221. Thus the flatness of the storage box formed after the plate body 31 with the magnetic component is connected to the first magnetic component 261 is ensured.

Continuing referring to FIGS. 8 to 10, in some embodiments, the first magnetic component 261 is provided on the third surface 26 of the connector body 20, and the third surface 26 is not provided with the first snap-fit portion 21, the second snap-fit portion 22, the first plug-in structure 231 or the second plug-in structure 241.

When the connector and the plate 30 are assembled into a storage box, the plate body 31 with a magnetic component can be magnetically connected to the first magnetic component 261, so that the plate body 31 with the magnetic component can be disassembled from the connector without removing the plate 30 from the first plug-in structure 231 of the connector, so as to realize the picking and placing of the items in the storage box.

Referring to FIG. 10, in some embodiments, the outer surface 2611 of the first magnetic component 261 is align with the third surface 26 to prevent the first magnetic component 261 from falling off the connector body 20 due to bumps.

In some embodiments, the first magnetic component 261 is a magnet.

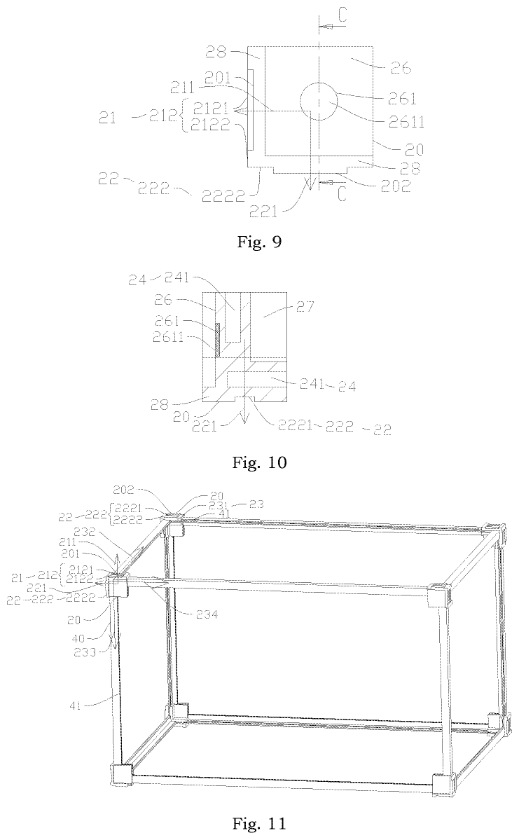

Referring to FIGS. 8 and 9, in some embodiments, the third surface 26 is perpendicular to the first surface 201 and the second surface 202. Thus the flatness of the storage box formed after the plate body 31 with the magnetic component is connected to the first magnetic component 261 is ensured.

Referring to FIGS. 8 to 10, in some embodiments, the third surface 26 is adjacent to the first surface 201 and the second surface 202. Thus the flatness of the storage box formed after the plate body 31 with the magnetic component is connected to the first magnetic component 261 is ensured.

Continue referring to FIGS. 8 and 9, in some embodiments, a third prism 28 is integrally formed, processed, or connected to the edges of the third surface 26 intersecting the first surface 201 and the second surface 202. This prevents the plate 30 magnetically connected to the first magnetic component 261 from separating from the first magnetic component 261 due to collision.

As shown in FIG. 10, when the connector is further provided with a second groove 27, the second groove 27 is provided on a surface other than the first surface 201, the second surface 202, or the third surface 26.

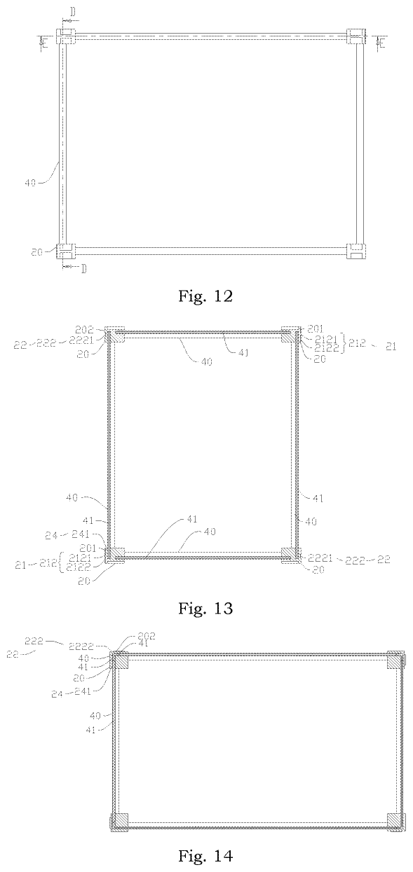

FIGS. 11 to 14 schematically show a storage box according to the first embodiment of the present invention.

Referring to FIGS. 11 to 14, the storage box comprises eight connectors and three sets of ribs. Each set of ribs comprises two ribs 40 of equal length, the ribs 40 are cooperated with the second plug-in structure 241 and both ends of the ribs 40 are connected with connectors so as to connect to form a frame structure, then the plate body 31 can be placed on the frame to form a storage box. When the eight connectors are connected to form a frame by means of the three sets of ribs, the first surface 201 or the second surface 202 of the connector on the diagonal of the frame faces the same side, the first surface 201 of one of the connectors connected with both ends of the same rib 40 respectively and the second surface 202 of the other connector face the same side, so that different frames can be nested with each other by means of the connectors to be stably stacked.

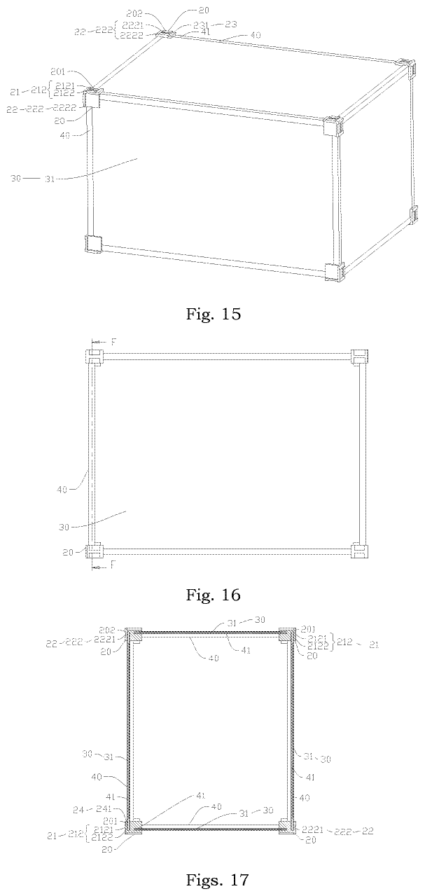

FIGS. 15 to 18 schematically show a storage box according to a second embodiment of the present invention.

Referring to FIGS. 15 to 18, in some embodiments, a mounting groove 41 cooperated with the plate body 31 is integrally formed or processed on the rib 40, and the mounting groove 41 is configured such that when the rib 40 is plugged into the second plug-in structure 241, the mounting groove 41 communicates with the groove if the first plug-in structure 231 to form a communicating groove, so as to plugged into the first insertion structure 231 and the mounting groove 41 at the same time with the plate body 31, so that the side edges of the plate body 31 can be protected by the ribs 40 and the strength of the storage box can be improved.

In some embodiments, the plate body 31 may be made of a transparent material, for example, PVC, ABS, organic glass, etc., to reduce the weight of the storage box.

In other embodiments, the plate body 31 can be plugged into the mounting groove 41 and the first plug-in structure 231 at the same time to further ensure the stability of the plugging of the plate body 31.

In still other embodiments, the storage box comprises eight connectors and three sets of plates; each set of plates is provided with at least one plate body cooperated with the first plug-in structure; at least one set of plates of the three sets of plates comprises two plates with the same shape, and each set of plates comprises at most two plates. When each set of plates comprises two plates, the two plates in one same set have the same shape; Four corners of each plate body are individually cooperated with a connector; the plate bodies in each two sets of plates are arranged perpendicular to each other; two plate bodies in one set of plates are arranged parallel to each other; the connector is the aforementioned connector.

When using, the plate body can be plugged into the first plug-in structure of the connector to assemble into a storage box; after the storage box being assembled, the first snap-fit portion and the second snap-fit portion on the connector body are located outside the storage box.

Continue referring to FIGS. 15 to 18, in some embodiments, the storage box further comprises a rib 40 cooperated with the second plug-in structure 241, the mounting groove 41 cooperated with the plate body 31 is integrally formed or processed on the rib 40; both ends of the rib 40 are connected with connectors. Therefore, the side edges of the plate body 31 can be protected by the ribs 40, and the strength of the storage box can be improved.

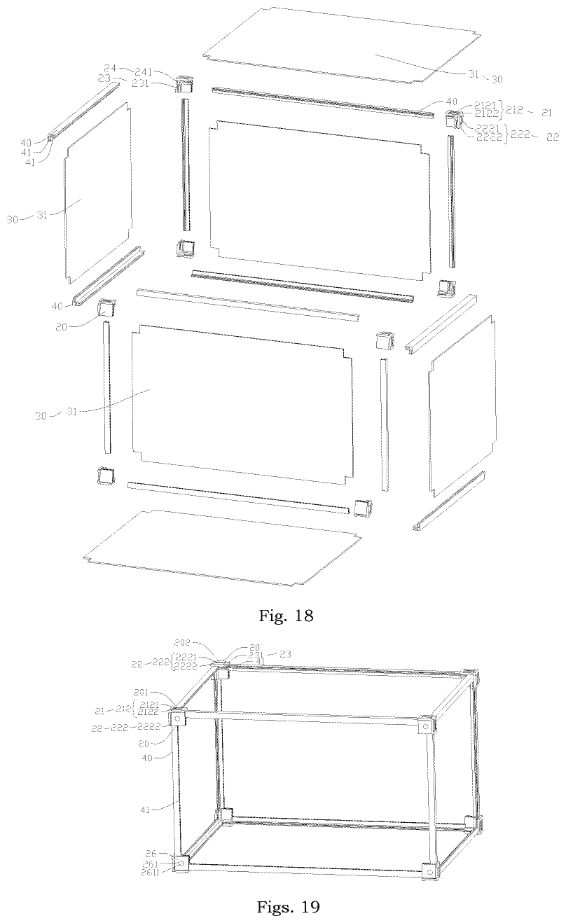

Referring to FIG. 18, in some embodiments, two mutually perpendicular mounting grooves 41 are integrally formed or processed on the rib 40, and arranged such that when the rib 40 is cooperated in the second plug-in structure 241, each mounting groove 41 individually communicates with a first plug-in structure 231. Therefore, all the side edges of the plate body 31 can be protected by the ribs 40, and the strength of the storage box can be improved.

Regardless of implementing the storage box of the first embodiment or the second embodiment, when a plurality of storage boxes are stacked together, the first snap-fit portion 21 on the connector of one storage box is nested with the second snap-fit portion 22 on the connector of the adjacent storage box to avoid storage boxes stacked together from sliding relative to each other, thereby ensuring that the plurality of storage boxes can be stacked together stably (referring to FIGS. 23 and 24).

FIG. 19 schematically shows a storage box according to a third embodiment of the present invention.

Referring to FIG. 19, the difference between the storage box of the third embodiment and the first embodiment is that the third surface 26 of the connector in this embodiment is provided with a second magnetic component 311.

In some embodiments, the second magnetic component 311 is a magnet.

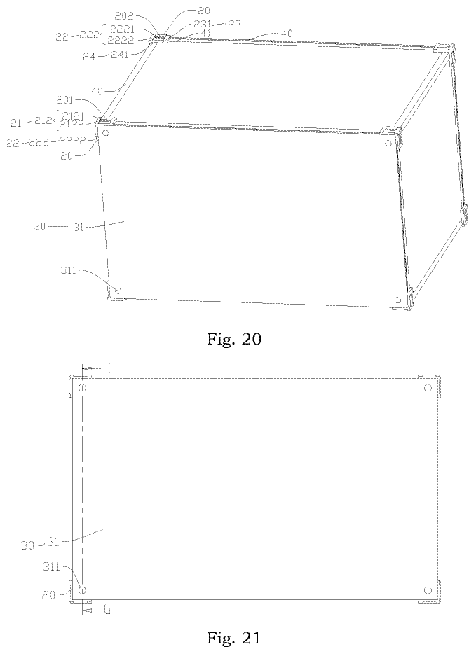

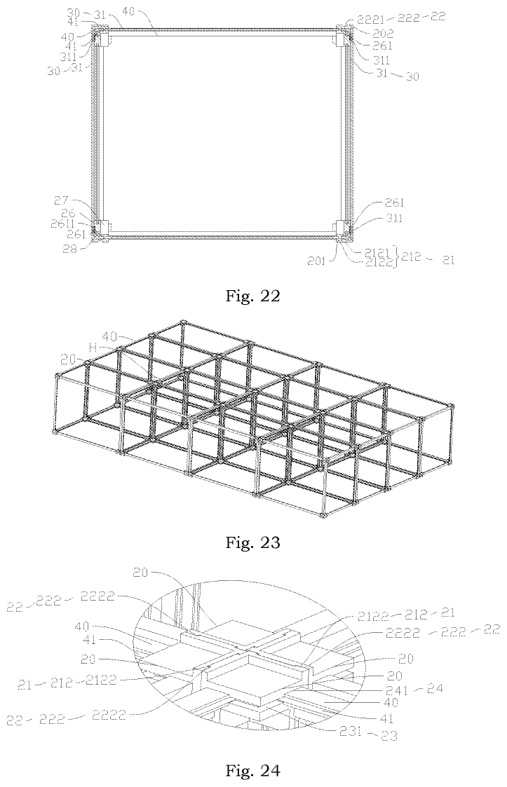

FIGS. 20 to 22 schematically show a storage box according to a fourth embodiment of the present invention.

Referring to FIGS. 20 to 22, the difference between the storage box of the fourth embodiment and the second embodiment is that the third surface 26 of the connector in this embodiment is provided with a second magnetic component 311.

In other embodiments, the storage box comprises eight connectors and three sets of plates; each set of plates is provided with at least one plate body cooperated with the first plug-in structure; at least one set of the three sets of plates comprises two plates with the same shape; four corners of the plate of two sets of plates are individually cooperated with one connector, and four corners of at least one plate body of the other plate are provided with a second magnetic component corresponding to the first magnetic component; the plate bodies of each two sets of plates are arranged perpendicular to each other; two plate bodies in one set of plates are arranged parallel to each other; the connector is the aforementioned connector.

The method of application can be similar to the method of application of the storage box of the first to the third embodiments, moreover the plate body 31 without the second magnetic component 311 can further be plugged into at least one of the first plug structure 231 and the second plug structure 241, and the plate body 31 provided with the second magnetic component 311 magnetically connects to the first magnetic component 261 of the connector.

After the storage box being assembled, the first snap-fit portion 21 and the second snap-fit portion 22 on the connector body 20 are located outside the storage box.

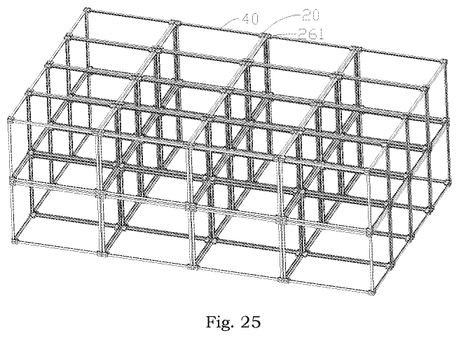

Therefore, when a plurality of storage boxes are stacking together, the first snap-fit portion 21 on the connector of one storage box and the second snap-fit portion 22 on the connector of the adjacent storage box are nested with each other, so as to avoid the plurality of storage boxes stacked together from sliding mutually, ensuring that the plurality of storage boxes can be stacked together stably; further, the plate 30 with the magnetic component can be disassembled from the connector without removing the plate 30 from the first plug-in structure 231 of the connector, to realize the picking and placing of the items in the storage box; the storage boxes stacked mutually can further be attracted to each other by means of the first magnetic component 261 provided on the third surface 26 or the second magnetic components 311 provided on the plate 30, so as to avoid relative slippage of the storage boxes stacked mutually when being collided (referring to FIG. 25).

In some embodiments, the connectors and the ribs 40 may be made of plastic materials to reduce the weight of the storage box.

In other embodiments, the connectors and the ribs 40 may be made of high-strength materials, for example, such as metals, etc.

For example, high-strength and light-weighted metal materials such as aluminum alloy are used to make the ribs 40 and the connectors. Thus, even if the plate 30 is made of a non-high-strength material, the high strength of the frame of the storage box can still be maintained, thereby reducing the cost of the material.

In the present invention, the installation can be implemented by a detachable installation method in the prior art, such as threaded connection; or a non-detachable installation method in the prior art, such as welding. The present invention does not limit the specific implementation of the fixed installation.

What has been described above are only some embodiments of the present invention. For those of ordinary skilled in the art, several modifications and improvements can be made, and these all fall within the protection scope of the present invention, without departing from the inventive concept of the present invention.

1. A connector, characterized in that it comprises a connector body;
the surface of the connector body extending along a first direction vector to form a first snap-fit portion;
the surface of the connector body extending along a second direction vector to form a second snap-fit portion be able to nest with the first snap-fit portion, the first direction vector and the second direction vector being perpendicular to each other, the distance between the second snap-fit portion and the first snap-fit portion increasing or remaining unchanged as the second snap-fit portion extends;
the connector body provided with at least one of a first plug-in unit and a second plug-in unit,
wherein the first plug-in unit comprises three first plug-in structures provided on the surface of the connector body and formed by extending along a third direction vector, a fourth direction vector and a fifth direction vector respectively, any two of the third direction vector, the fourth direction vector and the fifth direction vector being perpendicular to each other, neither of them being in the same direction with the first direction vector or the second direction vector, at least one of the third direction vector, the fourth direction vector and the fifth direction vector being perpendicular to the first direction vector,
wherein the second plug-in unit comprises three second plug-in structures provided on the surface of the connector body and formed by extending along the third direction vector, the fourth direction vector and the fifth direction vector respectively;
when the first plug-in unit and the second plug-in unit being both provided, the second plug-in structure being arranged to connect two adjacent first plug-in structures.

2. The connector according to claim 1, characterized in that the contours of the first snap-fit portion and the second snap-fit portion are arranged such that when the first snap-fit portion and the second snap-fit portion expand relative to the first axis, the contour of the first snap-fit portion and the contour of the second snap-fit portion is symmetrical with respect to the first axis;
the first axis being formed on the intersection of a first plane perpendicular to the first direction vector and a second plane perpendicular to the second direction vector.

3. The connector according to claim 2, characterized in that the first snap-fit portion and the second snap-fit portion are arranged such that when the first snap-fit portion of one connector is nested with the second snap-fit portion of the other connector, the first direction vector of one connector is parallel and opposite to the second direction vector of the other connector.

4. The connector according to claim 3, characterized in that the first snap-fit portion is a protrusion provided on the surface of the connector body, and the second snap-fit portion is a first groove provided on the surface of the connector body and cooperated with the protrusion.

5. The connector according to claim 4, characterized in that the protrusion comprises:
at least one first prism and at least one second prism not parallel to the first prism provided on the surface of the connector body.

6. The connector according to claim 5, characterized in that the first prism is provided at a non-end portion of the second prism.

7. The connector according to claim 6, characterized in that the first prism is located in the middle portion of the second prism, the first prism and the second prism both arranged as a strip structure with equal width extending straightly, and the first prism being perpendicular to the second prism.

8. (canceled)

9. The connector according to claim 7, characterized in that the protrusion being provided on the first surface perpendicular to the first direction vector of the connector body, the first groove being provided on the second surface perpendicular to the second direction vector of the connector body, the second surface is adjacent to the first surface.

10. The connector according to claim 9, characterized in that the height of the protrusion is equal to the depth of the first groove.

11. (canceled)

12. The connector according to claim 9, characterized in that the surface of the connector body is provided with a first magnetic component, the outer surface of which being parallel to both the first direction vector and the second direction vector.

13.-16. (canceled)

17. The connector according to claim 12, characterized in that the first magnetic component is provided on the third surface not provided with the first snap-fit portion, the second snap-fit portion, the first plug-in structure or the second plug-in structure of the connector body.

18.-21. (canceled)

22. The connector according to claim 17, characterized in that the third surface is perpendicular to the first surface and the second surface, the third surface being adjacent to the first surface and the second surface.

23.-26. (canceled)

27. A storage box, characterized in that it comprises eight connectors and three sets of plates;
each set of plates being provided with at least one plate body cooperated with the first plug-in structure;
at least one set of the three sets of plates comprising two plates with the same shape;
the four corners of each plate body being individually cooperated with one connectors;
the plate bodies of each two sets of plates being arranged perpendicular to each other;
two plate bodies of one set of plates being arranged parallel to each other;
the connector being the connector according to claim 1.

28. The storage box according to claim 27, characterized in that further comprising a rib cooperated with the second plug-in structure and provided with a mounting groove cooperated with the plate body;
both ends of the rib being connected with the connector.

29. The storage box according to claim 28, characterized in that the ribs are provided with two mutually perpendicular mounting grooves and arranged such that when the ribs are cooperating with the second plug-in structure, each mounting groove is individually communicated with one first plug-in structure.

30. The storage box according to claim 29, characterized in that the depth of the second plug-in structure is greater than the depth of the first plug-in structure.

31. A storage box, characterized in that it comprises eight connectors and three sets of plates;
each set of plates being provided with at least one plate body cooperated with the first plug-in structure;
at least one set of the three sets of plates comprising two plate bodies with the same shape;
the four corners of the plates of the two sets of plates being individually cooperated with one of the connectors, and the four corners of at least one plate of the other set of plates being provided with a second magnetic component corresponding to the first magnetic component;
the plate bodies of each two sets of plates being arranged perpendicular to each other;
two plate bodies of one set of plates being arranged parallel to each other;
the connector being the connector according to claim 12.

32. The storage box according to claim 31, characterized in that further comprising a rib cooperated with the second plug-in structure and provided with a mounting groove cooperated with the plate body;
both ends of the rib being connected with the connectors.

33. The storage box according to claim 32, characterized in that the ribs are provided with two mounting grooves perpendicular to each other and arranged such that when the ribs are cooperating with the second plug-in structure, each mounting groove is individually communicated with one first plug-in structure.

34. The storage box according to claim 33, characterized the depth of the second plug-in structure is greater than the depth of the first plug-in structure.
